(19) United States
(12) Patent Application Publication
(10) Pub. No.: US 2022/0342469 A1
(43) Pub. Date: Oct. 27, 2022

(54) POWER BUDGET PROFILES OF COMPUTING DEVICES

(71) Applicant: Hewlett-Packard Development Company, L.P., Spring, TX (US)

(72) Inventors: Chu-Ching CHEN, Taipei (TW); Ming-Hong LEE, Taipei (TW); Chun CHANG, Taipei (TW); Li-Pin LU, Taipei (TW)

(73) Assignee: Hewlett-Packard Development Company, L.P., Spring, TX (US)

(21) Appl. No.: 17/239,531

(22) Filed: Apr. 23, 2021

(51) Int. Cl. G06F 1/28; G06F 11/30; G06F 11/34

(52) U.S. Cl. CPC G06F 1/28; G06F 11/3024; G06F 11/3062; G06F 11/3476; G06F 13/4282

(57) ABSTRACT

Adaptive power management of a computing device is provided such that computer power can be dynamically allocated and adjusted among CPU and other power consuming peripherals based on the power usage pattern of individual users. Power overuse (surge and/or agency) events occurred during a time period (e.g., a week) are recorded in a database. By analyzing the recorded power overuse events, the computing device can be operated under a customized power budget profile learned from the user's power usage pattern, allowing different weight to different power consuming components, so as to optimize the performance of the computing device based on the usage scenario of different users at different time.

### BACKGROUND

A computing device may include a plurality of components, such as a processor, memory, etc. Each component may be allocated a certain amount of power for operation.

### BRIEF DESCRIPTION OF THE DRAWINGS

FIGS. 1A and 1B illustrates example schematic diagrams of a computing device.

FIG. 2 illustrates an example flow diagram of self-adaptive power management of this disclosure.

FIG. 3 illustrates an example flow diagram of power budget profile determination of this disclosure.

FIG. 4 illustrates an example power overuse log and an example power budget profile for a first time period.

FIG. 5 illustrates the power overuse log in FIG. 4 with an updated power budget profile in view of the power usage scenario in the first time period.

FIG. 6 illustrates an example power overuse log for a second time period and the power budget profile in FIG. 5.

FIG. 7 illustrates the power overuse log in FIG. 6 with an updated power budget profile in view of the power usage scenario in the second time period.

### DETAILED DESCRIPTION

Power budget management of a computing device may rely on pre-calculated power budget profiles stored in a power budget database. Each of the power budget profiles may correspond to a possible computer usage scenario contemplated by the engineers. Once stored in the power budget database, the pre-calculated power budget profiles are fixed and cannot be modified.

This disclosure provides a mechanism for learning different power usage scenarios of a user and dynamically allocating power between power consuming devices (such as, CPU, GPU, and peripheral devices) based on such actual usage scenarios, so as to improve computer performance and user experiences. By logging and analyzing the usage behavior pattern when power overuse events are triggered, power budget profiles can be automatically calculated and updated, thereby constantly approaching to the optimized power allocation for each usage scenario.

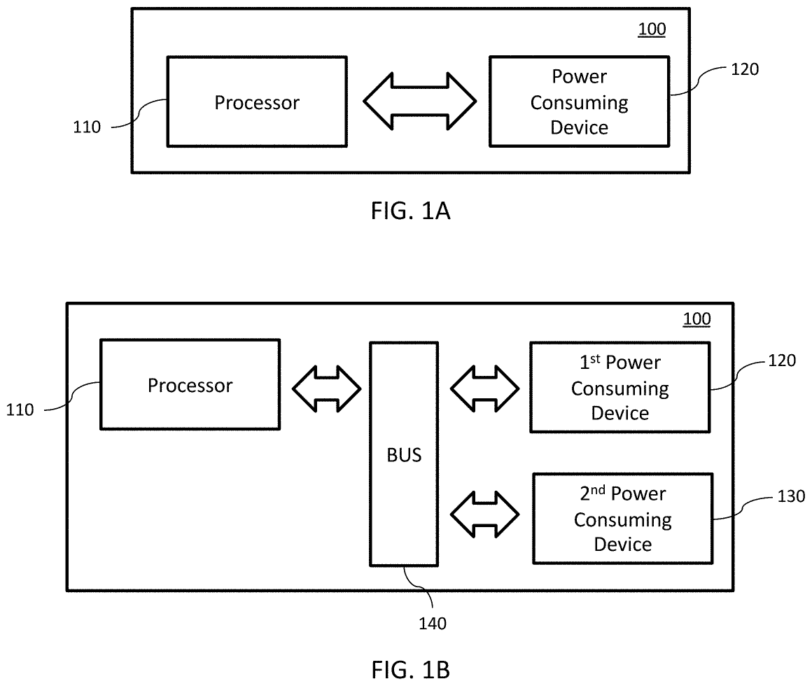

FIGS. 1A and 1B illustrates example schematic diagrams of a computing device 100. As show in FIG. 1A, in one example, computing device 100 includes a central processing unit (CPU) or processor 110 and a power consuming device 120 electrically connected with processor 110. Processor 110 allocates power to itself and power consuming device 120 based on a first power budget profile. The first power budget profile is determined based on respective average and maximum power weights associated with the processor and the power consuming device. Processor 110 monitors power usages of itself and power consuming device 120. Processor 110 records respective power consumption information of itself and power consuming device 120 when a total power consumption of the computing device exceeds a threshold value during a time period. Processor 110 determines a second power budget profile based on the respective power consumption information. Processor 110 replaces the first power budget profile with the second power budget profile.

As shown in FIG. 1B, in another example, computing device 100 includes processor 110, a first power consuming device 120, and a second power consuming device 130. Processor 110 can be electrically connected with first power consuming device 120 and second power consuming device 130 via a bus 140. Processor 100 monitors a power budget profile in a power budget database for a time period. The power budget profile including a first power weight associated with the power consuming devices. Processor 100 retrieves a power overuse log in the power budget database, the power overuse log including a plurality of power overuse records. Processor 100 calculates a second power weight of the power budget profile associated with the power consuming devices. Processor updates the power budget profile when the second power weight is different from the first power weight.

In various examples, first and second power consuming device 120 and 123 can be a random-access memory (RAM) or volatile memory, a read-only memory (ROM) or non-volatile memory, a graphics processing unit (GPU), and a peripheral device. ROM may be electrically erasable and programmable/reprogrammable. GPU may be a dedicated/discrete GPU (dGPU) or an integrated GPU (iGPU). The peripheral device may be a type-C peripheral device connected to the computing device 100 through, for example, a type-C universal serial bus (USB) interface. In some examples, computing device 100 may include additional power consuming devices connected thereto.

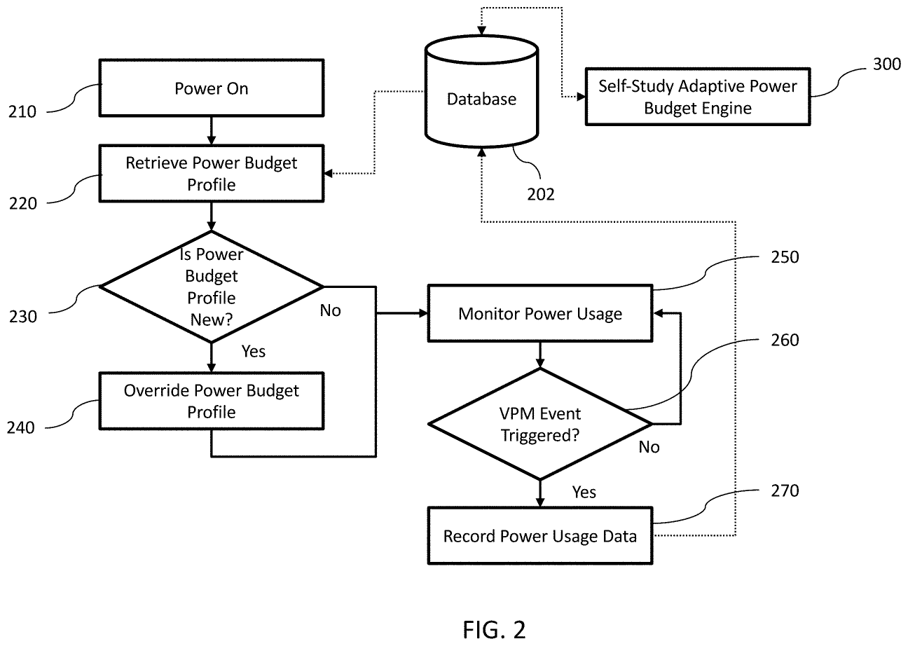

FIG. 2 illustrates an example flow diagram of self-adaptive power management of this disclosure. Referring to both FIGS. 1 and 2, in Step 210, computing device 100 is powered on. If computing device 100 is powered on for the first time, processor 110 can allocate electric power to processor 110 and other power consuming devices based on a default power budget profile. If computing device 100 has been powered on before, processor 110 can allocate electric power to processor 110 and other power consuming devices based on a previously used power budget profile. The previously used or default power budget profile may be loaded to volatile memory 120 from a database 202, such that processor 110 can allocate power accordingly.

In Step 220, after computing device 100 has been powered on for some time, processor 110 retrieves a power budget profile of computing device 100 from database 202. In one example, processor 110 can retrieve the power budget profile periodically (e.g., once every week or every two weeks) or as needed (e.g., once database 202 exceeds a certain size). The power budget profile can be determined based on respective average and maximum power weights associated with processor 110 and other power consuming devices to be further detailed below. In one example, database 202 is stored in non-volatile memory 130. In other examples, database 202 can be stored in a local storage device (e.g., a hard drive) included in computing device 100 or a remote storage device communicably connected to computing device 100 via a computer network.

In Step 230, processor 110 compares the power budget profile with a previously used or default power budget profile, and determines whether the power budget profile is different from and thus new with respect to the previously used or default power budget profile.

In Step 240, if the power budget profile is new, processor 110 overrides the previously used or default power budget profile in volatile memory 120 using the new power budget profile, and allocates electric power to processor 110 and other power consuming devices using the new power budget profile.

In Step 250, if the power budget profile is not new, processor 110 continues to measure and monitor the power consumption of each power consuming device of computing device 100.

In Step 260, processor 110 determines whether a total power consumption of computing device 100 exceeds a threshold value, i.e., whether a power surge or agency event occurs. In one example, a power surge event occurs when a total power consumption of computing device 100 exceeds a first threshold value (e.g., 70 W), while a power agency event occurs when a total power consumption of computing device 100 exceeds a second threshold value (e.g., 80 W) greater than the first threshold value.

In Step 270, if a power surge or agency event occurs at a time point T (or a VPM event is triggered), processor 110 stores the power consumption information of each power consuming device at time T in database 202 as a power overuse record, and returns to Step 250. In one example, the power consumption information includes the Watt value of each power consuming device measured when the VPM event is triggered. The power consumption information of each power consuming device at different power surge or agency events are collected for a period of time in database 202 as a power overuse log including a plurality of power overuse records. The power overuse log can be analyze using a self-study adaptive power budget engine 300 to determine another power budget profile based on the collected power consumption information. In one example, self-study adaptive power budget engine 300 can be implemented as instructions stored in non-volatile memory 130 and executable by processor 110.

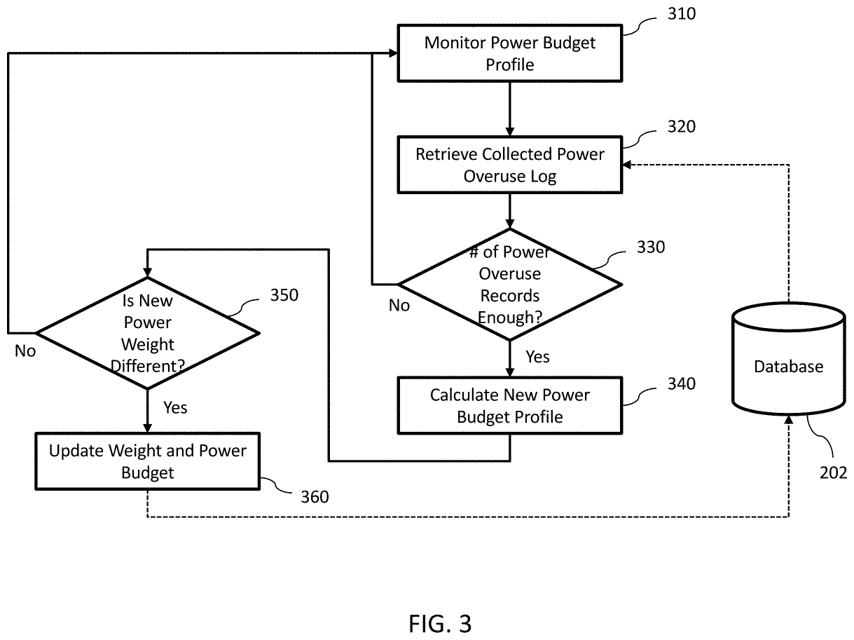

FIG. 3 illustrates an example flow diagram of power budget profile determination of this disclosure. In Step 310, engine 300 monitors a power budget profile of computing device 100 stored in database 202. In one example, the power budget profile includes average power weights and maximum power weights of each power consuming device of computing device 100. The average and maximum power weights can be expressed in Watts or any other suitable electric power units. The power budget profile can additionally include minimum power weights expressed in Watts or any other suitable units of each power consuming device of computing device 100.

In Step 320, at time T1 (e.g., one week after computing device 100 is powered on), engine 300 retrieves the collected power overuse log from database 202.

In Step 330, engine 300 determines whether the collected power overuse log includes a sufficient quantity of power overuse records. In one example, if the collected power overuse log includes five or less power overuse records, engine 300 determines that insufficient power overuse records are collected and returns to Step 310.

In Step 340, if more than five power overuse records are in the power overuse log, engine 300 calculates a new power budget profile based on the power overuse records collected in the power overuse log in view of an existing power budget profile. In one example, computing device 100 includes two power consuming devices A and B. A percentage power difference for power consuming device A can be calculated using below formula:

PowerDifference_A(T1)=(GreatestPower_A(T1)−AvgPower_A)/AvgPower_A,

where PowerDifference_A(T1) denotes the percentage power difference of power consuming device A at time T1, GreatestPower_A(T1) denotes the greatest power consumption of power consuming device A found in the power overuse log retrieved at time T1, and AvgPower_A denotes the average power weight assigned to power consuming device A in the original power budget profile. The percentage power difference for power consuming device B can be similarly calculated using the same formula.

In one example, a new maximum power weight and a new average power weight for power consuming device A can be calculated using below formula:

NewMaxPower_A=MaxPower_A+GreatestWeight_A, and

NewAvgPower_A=MaxPower_A+GreatestWeight_A,

where NewMaxPower_A denotes the new maximum power allocated to power consuming device A, MaxPower_A denotes the original maximum power allocated to power consuming device A, and GreatestWeight_A=GreatestPower_A(T1)−AvgPower_A.

In one example, a new maximum power weight and a new average power weight for power consuming device B can be calculated using below formula:

NewMaxPower_B=MaxPower_B−TakenPower_B, and

AvgPower_B=AvgPower_B−TakenPower_B,

where NewMaxPower_B denotes the new maximum power allocated to power consuming device B, MaxPower_B denotes the original maximum power allocated to power consuming device B, and TakenPower_B denotes the power taken away from power consuming device B for power consuming device A. As a result, the new power budget profile can be created by updating the existing power budget profile with the new maximum and average power weights of power consuming devices A and B.

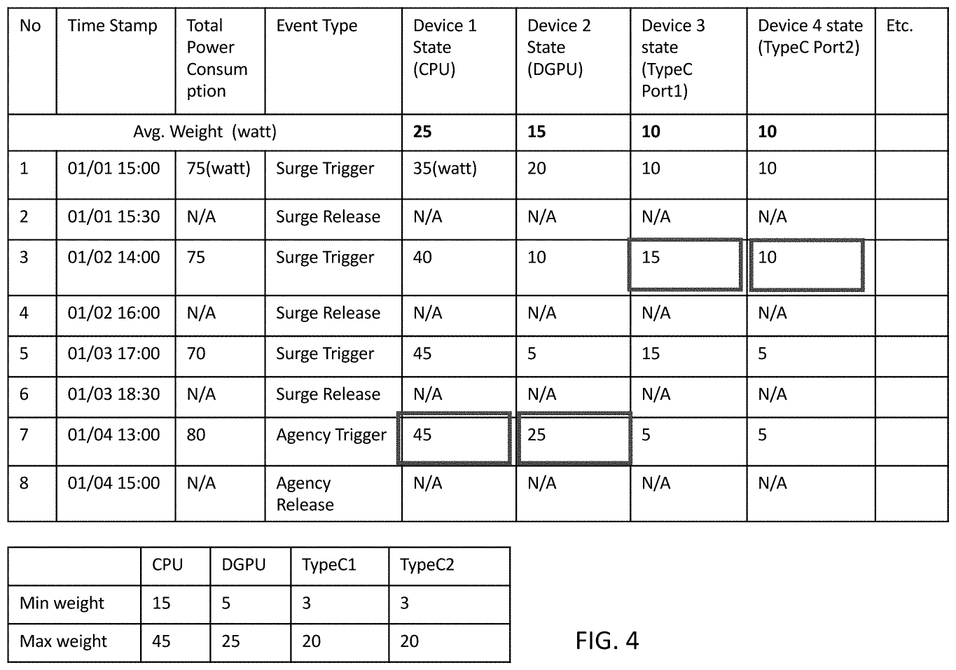

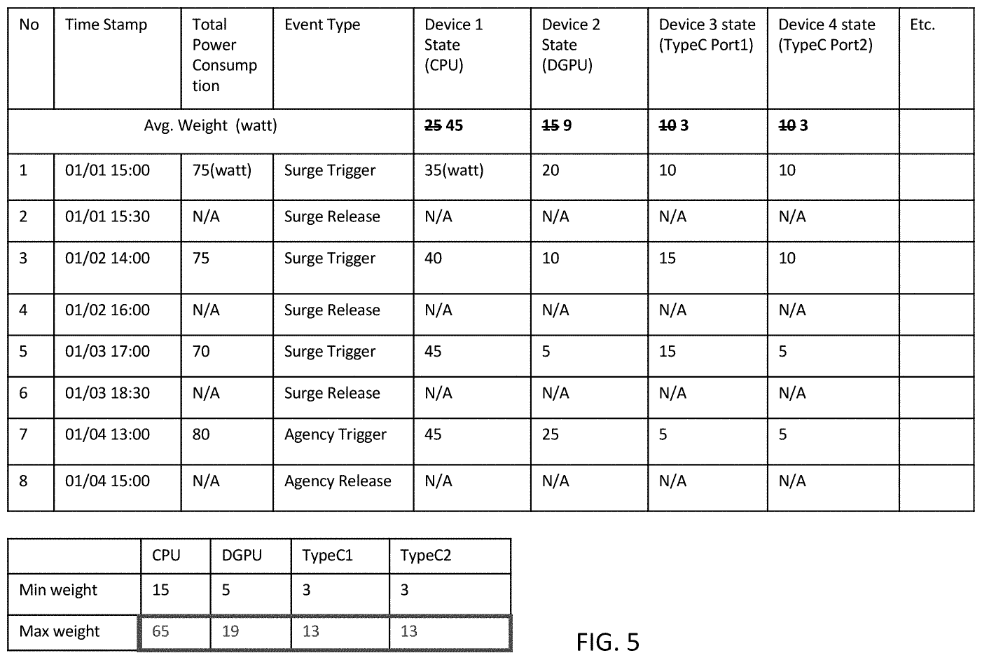

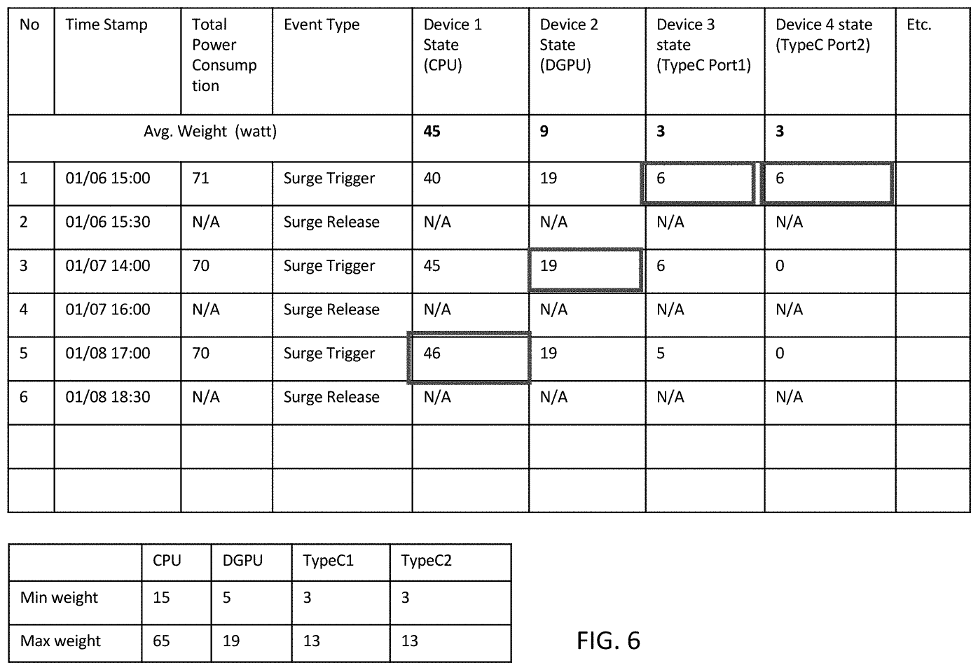

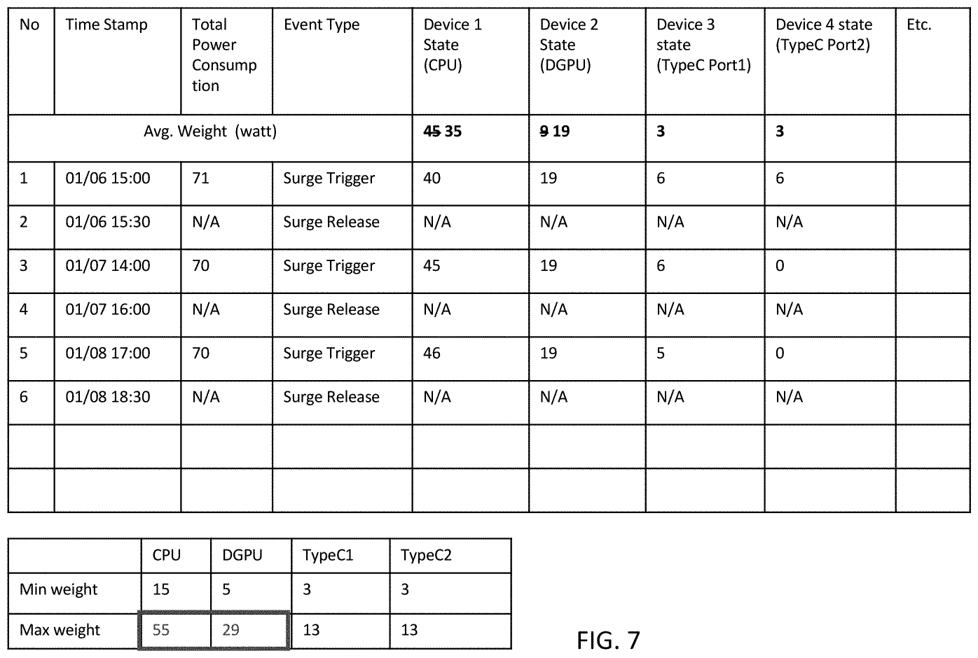

FIG. 4 illustrates an example power overuse log and an example power budget profile for a first time period. FIG. 5 illustrates the power overuse log in FIG. 4 with an updated power budget profile in view of the power usage scenario in the first time period. FIG. 6 illustrates an example power overuse log for a second time period and the power budget profile in FIG. 5. FIG. 7 illustrates the power overuse log in FIG. 6 with an updated power budget profile in view of the power usage scenario in the second time period.

In the example of FIGS. 4 through 7, computing device 100 include four power consuming devices, namely, a CPU, a DGPU, a first type-C device at port 1 and a second type-C device at port 2.

As shown in FIG. 4, the percentage power difference for the CPU is the greatest (i.e., 80%=(45−25)/25). Accordingly, as shown in FIG. 5, the new maximum power weight for the CPU increases from 45 W to 65 W, and the average the new maximum power weight for the CPU increases from 25 W to 45 W. The new maximum power weights for the DGPU and the first and second type-C devices respectively decrease by 6 W (from 15 W to 9 W), 7 W (from 10 W to 3 W), and 7 W (from 10 W to 3 W), because a total of 20 W has been taken from them and reallocated to the CPU.

As shown in FIG. 6, the percentage power difference for the DGPU is the greatest (i.e., 111%=(19−9)/9). Accordingly, as shown in FIG. 7, the new maximum power weight for DGPU increases from 19 W to 29 W, and the average the new maximum power weight for DGPU increases from 9 W to 19 W. The new maximum power weights for the CPU decreases by 10 W (from 65 W to 55 W), because 10 W has been taken from it and reallocated to the DGPU. The maximum and average power weights for the first and second type-C devices remain unchanged because their greatest power consumptions during the second time period is too small to justify any power weight adjustments.

Some or all of the method steps and/or functions described above may be implemented as computer readable instructions executable by a processor and stored in a non-transitory computer readable memory or storage medium, where the term “non-transitory” does not encompass transitory propagating signals. Such computer readable instructions may exist as a software program in form of source code, object code, executable code, or other formats.

As used herein, Super Input/Output (super I/O or SIO) refers to an integrated circuit hardware on a computer motherboard or an expansion card that handles slower and less prominent input/output devices, such as, keyboard and mouse. In addition, a basic input/output system (BIOS) refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

For the purposes of describing and defining the present disclosure, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue. Unless otherwise stated herein, any numerical values appeared in this specification are deemed modified by a term of degree thereby reflecting their intrinsic uncertainty.

Although various embodiments of the present disclosure have been described in detail herein, one of ordinary skill in the art would readily appreciate modifications and other embodiments without departing from the spirit and scope of the present disclosure as stated in the appended claims.

What is claimed is:

1. A computing device, comprising:
a power consuming device; and
a processor to:
allocate power to the processor and the power consuming device based on a first power budget profile, wherein the first power budget profile is determined based on respective minimum, average and maximum power values associated with the processor and the power consuming device;
monitor power usages of the processor and the power consuming device;
record a power consumption information record when a total power consumption of the computing device exceeds a threshold value at a time point during a time period, wherein the respective power consumption information record comprises power consumption information of the processor and the power consuming device;
determine a second power budget profile based on a plurality of power consumption information records recorded at different time points; and
replace the first power budget profile with the second power budget profile.

2. The computing device of claim 1, wherein the power consuming device includes a graphics processing unit (GPU).

3. The computing device of claim 2, wherein the power consuming device further comprises a Universal Serial Bus (USB) type-C peripheral device.

4. The computing device of claim 1, further comprising a non-volatile memory including a power budget database stored therein, the processor to retrieve the first power budget profile from the power budget database before power is allocated.

5. The computing device of claim 4, wherein the processor to retrieve the second power budget profile from the power budget database after the computing device is powered on for a time period and before power is reallocated.

6. The computing device of claim 1, wherein the processor to determine the second power budget profile comprises the processor to:
identify respective greatest power consumption values of the processor and the power consuming device in the respective power consumption information of the processor and the power consuming device;
calculate respective percentage power difference values of the processor and the power consuming device using the respective greatest power consumption values and the respective average power values of the processor and the power consuming device;
calculate a weight increase value for one of the processor and the power consuming device having the greatest percentage difference value; and
add the weight increase value to the average and maximum power values of the one of the processor and the power consuming device to obtain the second power budget profile.

7. The computing device of claim 6, wherein the processor to subtract the weight increase value from the average and maximum power weights of the other of the processor and the power consuming device.

8. The computing device of claim 6, wherein the processor to subtract a value equal to or less than the weight increase value from the average and maximum power weights of the other one of the processor and the power consuming device.

9. A computing device, comprising:
a first power consuming device;
a second power consuming device; and
a processor to:
monitor a power budget profile in a power budget database for a time period, the power budget profile including respective first minimum, average and maximum power weights associated with the power consuming devices;
retrieve a power overuse log in the power budget database, the power overuse log including a plurality of power overuse records wherein each power overuse record comprises previously measured power consumption values associated with the power consuming devices at different time points within the time period;
calculate respective second power weights of the power budget profile associated with the power consuming devices;
update the power budget profile when the second power weight is different from the first power weight.

10. (canceled)

11. The computing device of claim 9, wherein the processor to calculate the second power weight of the power budget profile comprises the processor to:
identify respective greatest values among the power consumption values of respective power consuming devices;
calculate respective percentage power difference values of the power consuming devices using the respective greatest power consumption value and respective average power weight of the power consuming devices;
calculate a weight increase value for one of the power consuming devices having a greatest percentage difference value among the respective percentage difference values; and
add the weight increase value to the first power weight of one of the power consuming devices having the greatest percentage difference value.

12. The computing device of claim 11, wherein the processor further to subtract a value equal to or less than the weight increase value from the first power weights of the other ones of the power consuming devices.

13. The computing device of claim 9, wherein the processor to calculate the second power weight when a quantity of the power overuse records exceeds a threshold.

14. The computing device of claim 13, wherein the threshold is five records.

15. A computing device, comprising:
a power consuming device; and
a processor to:
allocate power to the processor and the power consuming device based on a first power budget profile, wherein the first power budget profile comprises minimum, average and maximum power weights associated with the processor and the power consuming device; and
retrieve a second power budget profile from a power budget database;
wherein when the second power budget profile is different from the first power budget profile, the processor to:
override the first power budget profile with the second power budget profile, and
allocate power to the processor and the power consuming device based on the second power budget profile; and
wherein when the second power budget profile is the same as the first power budget profile, the processor to:
monitor power usages of the processor and the power consuming device; and
store in the power budget database a plurality of power overuse records indicating when a total power consumption of the computing device exceeds a threshold value during a time period.

16. The computer device of claim 15, wherein the processor further to determine a third power budget profile based on the power overuse records when a quantity of the power overuse records exceeds a threshold.

17. The computing device of claim 16, wherein the threshold is five records.

18. The computer device of claim 16, wherein the processor to determine the third power budget profile comprises the processor to:
identify respective greatest power consumption values of the processor and the power consuming device in the power overuse records and respective average power consumption values of the processor and the power consuming device in the second power budget profile;
calculate respective percentage power difference values of the processor and the power consuming device using the respective greatest power consumption values and the respective average power values of the processor and the power consuming device;
calculate a weight increase value for one of the processor and the power consuming device having the greatest percentage difference value; and
add the weight increase value to the average and maximum power values of the one of the processor and the power consuming device to obtain the second power budget profile.

19. The computing device of claim 18, wherein the processor to subtract the weight increase value from the average and maximum power weights of the other of the processor and the power consuming device.

20. The computing device of claim 18, wherein the processor to subtract a value equal to or less than the weight increase value from the average and maximum power weights of the other one of the processor and the power consuming device.
